(19) United States
(12) Patent Application Publication
(10) Pub. No.: US 2023/0345937 A1
(43) Pub. Date: Nov. 2, 2023

(54) FATTY ACID-BASED HERBICIDE COMPOSITION

(71) Applicant: William Ernest Briggs

(72) Inventor: William Ernest Briggs

(73) Assignee: Contact Organics Technologies Pty Ltd, Hawthorn (AU)

(21) Appl. No.: 18/023,204

(22) PCT Filed: Aug. 26, 2021
(86) PCT No.: PCT/AU2021/050981

§ 371 Date: Feb. 24, 2023

(30) Foreign Application Priority Data
Aug. 27, 2020 (AU) 2020903066

(51) Int. Cl. A01N 25/22; A01N 25/04; A01N 37/02; A01P 13/00

(52) U.S. Cl. CPC A01N 37/02; A01N 25/04; A01N 25/22; A01P 13/00

(57) ABSTRACT

A herbicide composition having an acidic pH, the composition comprising water, a C₆-C₁₂ fatty acid, an alcohol alkoxylate, a hydrophobic liquid, pH sensitive hydrogel forming polymer and fumed silica.

### FIELD OF THE INVENTION

The present invention relates in general to the field of horticulture, agriculture and the control of undesirable plant growth. In particular, the invention relates to a fatty acid-based herbicide composition, a method of preparing the same and the use of and application thereof to kill a plant or retard its growth.

### BACKGROUND OF THE INVENTION

The use of herbicides to control undesirable plant growth is commonplace, both in domestic horticulture and commercial agriculture. Herbicides are also commonly used to control undesirable plant growth around infrastructure such as public amenities.

Whilst being beneficial, if not essential, in modern day horticulture/agriculture and infrastructure maintenance, a major drawback of many herbicides currently used is that they are toxic to humans, animals, and the environment in general.

Glyphosate (N-(phosphonomethyl)glycine) is a widely used broad-spectrum systemic herbicide and plant desiccant. Despite being an effective herbicide, extensive use of it has given rise to glyphosate tolerance in the field. Furthermore, there is mounting evidence to suggest its use is having a deleterious effect on the environment and human health. Consequently there is now a growing movement across the world to ban the use of glyphosate-based herbicide compositions.

Alternative and more environmentally friendly herbicide compositions are known. For example, compositions comprising fatty acids have been shown to exhibit herbicidal activity. After application the active fatty acid component in such compositions has been found to quite quickly decompose into relatively nontoxic residues. As an active herbicidal component, fatty acids therefore show promise. However, when used at recommended dosages conventional fatty acid-based herbicide compositions often require a relatively high concentration of fatty acid to promote an acceptable herbicidal activity. For example, application dosages for such conventional compositions is typically at least 30 kg/hectare fatty acid. Conventional fatty acid-based herbicide compositions also often require frequent application to achieve effective plant control. The need for higher active agent concentration and more frequent application can make use of such herbicide compositions economically unattractive. Despite fatty acids being less of an environmental concern (due to being naturally occurring and biodegradable) compared with other herbicide active agents, their use at relatively high concentration to achieve the desired herbicidal effect presents at least an economic impediment, if not an environmental concern.

Accordingly, there remains an opportunity to develop fatty acid-based herbicide compositions with improved efficacy, particularly where the fatty acid component can be used effectively at lower dosage rates and yet still prove effective.

### SUMMARY OF THE INVENTION

The present invention provides a herbicide composition having an acidic pH, the composition comprising water, a C₆-C₁₂ fatty acid, an alcohol alkoxylate, a hydrophobic liquid, a pH sensitive hydrogel forming polymer, and fumed silica, wherein the pH of the composition does not promote hydrogel formation of the pH sensitive hydrogel forming polymer.

The present invention also provides a method of preparing a herbicide composition, the method comprising:
providing an aqueous silica-containing composition comprising water, fumed silica, and a pH sensitive hydrogel forming polymer;
combining the aqueous silica-containing composition with an alcohol alkoxylate to form a liquid alcohol alkoxylate-containing composition; and
combining the liquid alcohol alkoxylate-containing composition with a C₆-C₁₂ fatty acid and a hydrophobic liquid to produce the herbicide composition;
wherein the so-formed herbicide composition has an acidic pH that does not promote hydrogel formation of the pH sensitive hydrogel forming polymer.

The present invention further provides a herbicide composition produced according to the method of the invention.

The present invention also provides a method of killing a plant or retarding its growth, the method comprising contacting the plant with a herbicide composition according to the invention.

The present invention further comprises a method of controlling plant growth at a locus, the method comprising applying to the locus a herbicide composition according to the invention.

The present invention also provides use of a herbicide composition according to the invention to kill a plant or retard its growth.

The present invention yet further provides the use of a herbicide composition according to the invention to control plant growth at a locus.

Surprisingly, herbicide compositions in accordance with the invention have been found to exhibit improved herbicidal activity relative to conventional fatty acid-based herbicide compositions, particularly in terms of the need for lower dosage rates and less frequent application.

Notably, unlike conventional fatty acid-based herbicide compositions, those in accordance with the present invention can exhibit excellent herbicidal activity at fatty acid concentrations as low as 1 or 2 wt%. For example, herbicide compositions in accordance with the invention can advantageously be effectively used at a dosage rate of about 15 kg/hectare fatty acid.

The herbicide compositions in accordance with the invention of course also exhibit excellent herbicidal activity at high fatty acid concentrations, but it is the efficacy at low fatty acid concentrations that is particularly surprising and advantageous.

Without wishing to be limited by theory, the improved herbicidal activity of compositions in accordance with the invention is believed to result from the unique combination of the constituent components of the composition. In particular, the constituent components of the composition, other than the fatty acid, are believed to function as adjuvants to, in effect, enhance the herbicidal activity of the fatty acid component and make it more readily bioavailable.

Again, without wishing to be limited by theory, the C₆-C₁₂ fatty acid component of the herbicide composition in accordance with the invention is believed to promote so-called “burn-down” of plant tissue much in the same way as it does using conventional herbicide compositions. However, the adjuvant components used in the compositions according to the present invention have surprisingly been found to enhance the delivery and efficacy of the fatty acid component such that lower concentration of the fatty acid can be used while still achieving excellent herbicidal activity.

Such adjuvant components in the composition, namely water, alcohol alkoxylate, hydrophobic liquid, pH sensitive hydrogel forming polymer and fumed silica, collectively at an acidic pH that does not promote hydrogel formation of the pH sensitive hydrogel forming polymer are believed to provide an efficient vehicle to deliver the fatty acid component on to the surface of a plant and enhance uptake of the fatty acid component by the plant. The adjuvant components are believed to function individually and/or collectively in one or more ways to enhance delivery of the fatty acid component.

For example, the alcohol alkoxylate is believed to at least play a role in promoting stabilisation of the composition (as a concentrate or ready to spray composition) prior to application to a plant and also in enhancing adherence of the composition to the surface of the plant upon application.

The hydrophobic liquid is believed to at least minimise loss of the composition from the surface of a plant upon application and/or assist with removing/breakdown of the waxy cutin coating on the plant surface to promote desiccation and/or delivery of the fatty acid component into the plant tissue.

At the acidic pH of the composition the pH sensitive hydrogel forming polymer does not present as a hydrogel per se and imparts a limited increase in viscosity of the herbicide composition enabling it to be readily applied, for example by spraying. However, upon application of the herbicide composition to those plants having at least alkaline sap, the pH sensitive hydrogel forming polymer is believed to transition into a hydrogel thereby increasing the viscosity of its surroundings and greatly destabilize the plant metabolism. That in turn is believed to make the plant more vulnerable to the effects of the fatty acid component. Using the pH sensitive hydrogel forming polymer to generate a hydrogel during at least part of the manufacturing process of the herbicide composition may also facilitate promoting a high degree of dispersion of the fumed silica in the final composition.

The fumed silica component of the composition is believed to enhance transport of components of the herbicide composition into the plant tissue. Providing the fumed silica in a well dispersed form within in the herbicide composition is believed to be important in enhancing transport of components of the herbicide composition into the plant tissue

Collectively, all the constituent components of the composition have been surprisingly found to work synergistically and enhance the herbicidal efficiency of the fatty acid-based herbicide compositions.

The type of constituent components in the herbicide composition according to the invention and the lower concentration of those components typically used in practice renders the compositions much more economically and environmentally acceptable.

Further aspects and embodiments of the invention are discussed below in more detail.

### DETAILED DESCRIPTION OF THE INVENTION

The present invention provides a herbicide composition. As used herein, the term “herbicide” is intended to take its conventional meaning and define a composition comprising one or more constituent components capable of killing a plant or retarding the plant’s growth. Application of the herbicide will generally be employed for killing or retarding the growth of one or more undesirable plant species, for example, one or more weeds. The expression “herbicidal activity” therefore refers to the potential or realized function of the composition to act as a herbicide and kill a plant or retard a plant’s growth.

As will be discussed in more detail, the herbicide composition in accordance with the invention has an acidic pH. By the composition having an acidic pH is meant the pH of the composition is less than 7.

Herbicide compositions in accordance with the invention may be classified as a non-selective herbicide. In that context, the term “non-selective” refers to the spectrum of plant species against which the herbicide is active, with non-selective herbicides being active against most, if not all, plant species.

Common plant species to which the herbicide compositions according to the invention demonstrate herbicidal activity include, but are not limited to, annual broadleaf weeds (e.g. blackberry nightshade, capeweed, burr medic, creeping oxalis, milk thistle, spear thistle, wireweed, pigweed, fat hen, shepherd’s purse, algae, lichen, liverwort, moss) and annual grasses (e.g. annual ryegrass), perennial broad leaf weeds (e.g. flatweed, hair hawkbit, lamb’s tongue, dandelion, evening primrose, bell vine, white clover) and perennial grasses (e.g. couch grass, kikuyu, lovegrass, paspalum, volunteer wheat and perennial ryegrass).

Herbicide compositions in accordance with the invention are liquid-based and can be conveniently applied to a target plant(s) or locus using conventional liquid-based herbicide application means. Such application means include, but are not limited to, spray, pour or rub applications.

Herbicide compositions in accordance with the invention will generally be used as a post-emergent (i.e. application directly to a plant(s)) herbicide.

The herbicide composition according to the invention will typically be applied to make contact with at least some part of the plant structure situated above the ground. For example, the composition may be applied to the plant foliage and/or stem structure.

The herbicide composition is used in an amount and at a concentration of the constituent components to achieve the desired herbicidal activity. The desired herbicidal activity may be to kill the plant or simply to retard its growth. If required, the desired herbicidal activity may be achieved through multiple applications of the herbicide composition to a plant(s) or locus.

As those skilled in the art will appreciate, the amount of and concentration of the constituent components in the herbicide composition to be used in a given application will vary depending on a number of factors such as the plant species and the desired herbicidal activity outcome (i.e. to kill the plant or merely retard its growth). Having regard to the teaching herein, those skilled in the art will be able to readily select the amount of and concentration of the constituent components in the herbicide composition to be used in a given application.

The herbicide composition in accordance with the invention can advantageously be provided in a concentrate form that can be used directly or diluted with water depending upon the intended application. For example, the concentrate form of the composition may be used on hard wood plants such as blackberry or lantana by pouring it into root areas or application directly onto freshly cut stems, or the concentrate form may be diluted with water for use in spraying on, for example, broad leaf weeds or grasses.

Unless otherwise specified, as used herein the expression “wt.%” is intended to mean the percentage by weight of the specified component relative to the total weight of all components present in the herbicide composition.

According to the present invention the herbicide composition has an acidic pH. By having an acidic or acid pH is meant a pH of less than 7. Conversely, reference to an alkaline or basic pH is meant a pH greater than 7.

Generally, the pH of the herbicide composition will range from about 2 to about 5, or from about 3 to about 4.

As will be discussed in more detail below, the herbicide composition according to the invention includes a pH sensitive hydrogel forming polymer. Furthermore, that acidic pH does not promote hydrogel formation of the pH sensitive hydrogel forming polymer. Rather, the pH of the composition needs to be rendered more alkaline (i.e. move in the direction toward alkaline) for hydrogel formation of the pH sensitive hydrogel forming polymer to occur. Without wishing to be limited by theory, it is believed at the acidic pH of the composition the hydrogel-forming polymer will present in a non-ionised form and consequently does not form a hydrogel per se. However, as the pH of the composition increases toward an alkaline pH, the pH sensitive hydrogel forming polymer becomes ionised, which in turn promotes swelling and formation of the hydrogel. Formation of the hydrogel can cause a significant increase in the viscosity of the composition and/or a liquid environment in which the composition resides.

As herbicide compositions in accordance with the invention has an acidic pH that does not promote hydrogel formation of the pH sensitive hydrogel forming polymer, the hydrogel-forming polymer presents in its non-hydrogel state and consequently the polymer imparts a limited if no viscosity increase effect to the composition. That acidic form of the composition therefore enables it to be readily applied using conventional techniques such as spray application.

The acidic nature of the composition will typically be provided by one or more of the constituent components of the composition. For example, the fatty acid component and/or the pH sensitive hydrogel forming polymer can provide for the acidic pH of the composition.

Alternatively, one or more additional components may be included in the composition that provide for or assist with providing for the acidic pH of the composition. Such additional components may include, but are not limited to, hydrochloric acid and acetic acid.

In one embodiment, the composition in accordance with the invention comprises acetic acid.

Provided the herbicide composition in accordance with the invention is maintained with an acidic pH that does not promote hydrogel formation of the pH sensitive hydrogel forming polymer, the composition may include one or more additives for adjusting pH. For example, the composition may comprise conventional buffers and/or bases such as alkali metal hydroxides (e.g. sodium hydroxide).

Adjusting the pH of the herbicide composition may be helpful in the method of preparing the composition. Further detail in relation to that method is outlined below.

In one embodiment, sodium hydroxide is used as an agent to adjust the pH during manufacture of the herbicide composition.

In a further embodiment, the herbicide composition in accordance with the invention does not comprise potassium hydroxide.

The herbicide composition in accordance with the invention comprises water. In one embodiment, the water is de-mineralised water.

The amount of water present will generally vary from about 0.1 wt% to about 98 wt%.

The less water the composition contains, of course the more concentrated it will be. The concentration of the composition will often be tailored for a given application.

When referred to as a concentrate, the herbicide composition will typically comprises less than about 10 wt%, or less than about 7 wt%, or less than about 5 wt% water, or less than about 2 wt% water.

In one embodiment, water is present in the herbicide composition in an amount of less than about 10 wt%, or less than about 7 wt%, or less than about 5 wt%, or less than about 2 wt% water.

In another embodiment, water is present in the herbicide composition in an amount ranging from about 0.1 wt% to about 10 wt%, or about, or about 0.1 wt% to about 7 wt%, or about 0.1 wt% to about 5 wt%, or about 2 wt% to about 10 wt%, or about 2 wt% to about 7 wt%, or about 2 wt% to about 5 wt%.

As will be discussed below, the herbicide composition will typically be manufactured in a concentrate form and then optionally diluted with water for subsequent use.

Depending on the intended application, a concentrate form having about 2 wt% water can be diluted with additional water to provide, for example, a working spray composition using, for example, at a ratio of that concentrate to water of 1:5, 1:10, 1:15, 1:20, 1:25, 1:30 or even up to 1:40.

When referred to as a working spray composition, the herbicide composition will typically comprises at least about 50 wt%, or at least about 70 wt%, or at least about 80 wt% water.

In another embodiment, water is present in the herbicide composition in an amount ranging from about 50 wt% to about 98 wt%, or about 70 wt% to about 98 wt%, or about 80 wt% to about 98 wt%, or about 85 wt% to about 95 wt%.

In preparing such a working spray composition, some of the water used to dilute the concentrate composition may be substituted with acetic acid. For example, a working spray composition in accordance with the invention may comprise from about 1 wt.% to about 6 wt.% acetic acid.

In one embodiment, the herbicide composition produced in accordance with the method of the invention is combined with water and acetic acid to afford a ready to use herbicide composition having an acidic pH that does not promote hydrogel formation of the pH sensitive hydrogel forming polymer.

By the herbicide composition being provided in a “ready to use” form is meant the herbicide composition can be used in application without any further modification. In other words, the herbicide composition provides its constituent components at a concentration suitable for direct application.

The herbicide composition in accordance with the invention comprises a C₆-C₁₂ fatty acid. Reference to the fatty acid being “C₆-C₁₂” is meant that it will contain from 6 to 12 carbon atoms. The fatty acid may be a saturated, unsaturated, straight chain or a branched chain fatty acid.

The fatty acid component of the composition is a key active herbicidal agent.

In one embodiment, the fatty acid is a straight chain fatty acid.

By being a “fatty acid” it is intended to mean the carbon chain or “fatty” component is covalently attached to a carboxylic acid, where that carboxylic acid is in its protonated form (i.e. not in the form of a salt).

By the C₆-C₁₂ fatty acid being in its carboxylic acid form of those skilled in the art will appreciate it will have only limited solubility in the water component of the herbicidal composition. In other words, the fatty acid component presents primarily in the composition as an oil phase of an emulsion. Further detail concerning stabilisation that emulsion discussed below.

Those skilled in the art will nevertheless appreciate that despite only low solubility in water, high surface activity of the C₆-C₁₂ fatty acid still enables it to contribute to the acidic nature of the herbicide composition. Having said that, those skilled in the art will also appreciate that as the carbon chain length of fatty acids progresses past C12, their solubility in water is significantly decreased and such higher fatty acids have little if no impact on the pH of aqueous systems.

In one embodiment, the C₆-C₁₂ fatty acid is selected from caproic acid, enanthic acid, caprylic acid, nonanoic acid (also known as pelargonic acid), capric acid, udecylic acid, lauric acid, and sebacic acid.

In another embodiment, the fatty acid is selected from a C₈-C₁₂ fatty acid.

In a further embodiment, the C₆-C₁₂ fatty acid is nonanoic acid.

The C₆-C₁₂ fatty acid will generally be present in the herbicide composition in an amount ranging from about 1 wt% to about 60 wt%.

When referred to as a concentrate, the herbicide composition will typically comprise more than about 30 wt%, or more than about 40 wt%, or more than about 50 wt% C₆-C₁₂ fatty acid.

In one embodiment, the C₆-C₁₂ fatty acid is present in the herbicide composition in an amount more than about 30 wt%, or more than about 40 wt%, or more than about 50 wt%.

In another embodiment, the C₆-C₁₂ fatty acid is present in the herbicide composition in an amount ranging from about 30 wt% to about 60 wt%, or about 40 wt% to about 60 wt%, or about 50 wt% to about 60 wt%, or about 55 wt% to about 60 wt%.

When referred to as a working spray composition, the herbicide composition will typically comprise less than about 10 wt%, or less than about 5 wt%, or less than about 2 wt% C₆-C₁₂ fatty acid.

In one embodiment, the herbicide composition comprises less than about 10 wt%, or less than about 5 wt%, or less than about 2 wt% C₆-C₁₂ fatty acid.

In another embodiment, the C₆-C₁₂ fatty acid is present in the herbicide composition in an amount ranging from about 1 wt% to about 10 wt%, or about 1 wt% to about 5 wt%, or about 1 wt% to about 3 wt%, or about 1 wt% to about 2 wt%.

Unlike many conventional herbicide compositions, including those comprising fatty acids, an active herbicidal agent used in accordance with the present invention (i.e. the fatty acid) is provided in its acid form (i.e. not as a salt) and therefore has limited water solubility. The herbicide compositions in accordance with the invention therefore present the fatty acid component primarily in the form of an emulsion. That is in contrast with many conventional herbicide compositions that typically make use of a highly water soluble form of the active herbicidal agent, for example in the form of a metal or ammonium salt.

In one embodiment, the herbicide composition does not comprise a water soluble metal or ammonium salt of active herbicidal agent.

In another embodiment, the herbicide composition is provided in the form of an emulsion whereby active herbicidal agents are located in an oil phase of that emulsion.

The herbicide composition according to the invention also comprises alcohol alkoxylate.

The alcohol alkoxylate component in the composition facilitates with stabilising the emulsion form of the composition.

Alcohol alkoxylates are well known non-ionic surfactants derived from the alkoxylation of fatty alcohols.

The “alcohol” component or residue of the alcohol alkoxylate will generally be a C₆-C₂₄ alcohol. That alcohol component may be linear or branched. In one embodiment, the alcohol component is linear.

In one embodiment, the alcohol alkoxylate is a C₆-C₂₄ alcohol alkoxylate.

For avoidance of any doubt, the “C₆-C₂₄” in C₆-C₂₄ alcohol alkoxylate is intended to be a reference to the carbon atoms present in the alcohol residue.

The “alkoxylate” component of the alcohol alkoxylate refers to an oligomer or polymer built up from oxyalkylene units. The alkoxylate component may be branched or linear. In one embodiment, the alkoxylate component is linear.

When characterising the alcohol alkoxylate it can sometimes be convenient to refer to the number of oxyalkylene units that make up the alkoxylate component. The alkoxylate component will generally comprise about 4 to about 12, or from 9 to about 12 oxyalkylene units.

The alcohol alkoxylate may be represented by the general formula RO((CR^{x}R^{y})ᵢO)ⱼH, where R is C₆-C₂₄ alkyl, R^{X} and R^{Y} are each independently selected from hydrogen and alkyl, i is an integer ranging from 1 to 10 and j is an integer ranging from 4 to 12. Generally, R^{X} and R^{Y} are each independently selected from hydrogen and C₁₋₆ alkyl, and i is an integer selected from 2, 3, and 4. When i > 1, each (CR^{X}R^{Y}) may be the same or different. For example, when the oxyalkylene unit is an oxyethylene unit, R^{X} and R^{Y} are both hydrogen and i=2 (i.e. —O(CH₂)₂—), or where the oxyalkylene unit is an oxypropylene unit, i=2 and R^{X} and R^{Y} of the first “i” are both hydrogen and R^{X} and R^{Y} of the second “i” can respectively be hydrogen and methyl (i.e. —OCH₂CH(CH₃)—).

The oxyalkylene units may be derived from an alkylene oxide such as ethylene oxide, propylene oxide, or butylene oxide.

In one embodiment, the alcohol alkoxylate is an alcohol ethoxylate.

In another embodiment, the alcohol alkoxylate is a C₆-C₂₄ alcohol ethoxylate.

The alcohol alkoxylate used in accordance with the invention may be a mixture of different alcohol alkoxylates.

In one embodiment, the alcohol alkoxylate is a mixture of different alcohol alkoxylates.

In a further embodiment, the alcohol alkoxylate comprises a mixture of C₉-C₁₁ alcohol alkoxylate and C₁₆-C₁₈ alcohol alkoxylate.

In a further embodiment, the alcohol alkoxylate comprises a mixture of C₉-C₁₁ alcohol ethoxylate and C₁₈ alcohol ethoxylate.

Without wishing to be limited by theory, it is believed formulating the herbicide compositions in accordance with the invention using a mixture of C₉-C₁₁ alcohol alkoxylates and C₁₆-C₁₈ alcohol alkoxylates imparts excellent stability and application properties of the composition. That in turn is believed to afford improved application efficacy.

The alcohol alkoxylate will generally be present in the herbicide composition in an amount ranging from about 0.5 wt% to about 25 wt%.

When referred to as a concentrate, the herbicide composition will typically comprise more than about 10 wt%, or more than about 15 wt%, or more than about 20 wt% alcohol alkoxylate.

In one embodiment, the alcohol alkoxylate is present in the herbicide composition in an amount of more than about 10 wt%, or more than about 15 wt%, or more than about 20 wt%.

In another embodiment, the alcohol alkoxylate is present in the herbicide composition in an amount ranging from about 10 wt% to about 25 wt%, or about 15 wt% to about 25 wt%, or about 20 wt% to about 25 wt%.

When referred to as a working spray composition, the herbicide composition will typically comprise less than about 10 wt%, or less than about 5 wt%, or less than about 2 wt%, or less than about 1 wt% alcohol alkoxylate.

In one embodiment, the herbicide composition comprises less than about 10 wt%, or less than about 5 wt%, or less than about 2 wt%, or less than about 1 wt% alcohol alkoxylate.

In another embodiment, the alcohol alkoxylate is present in the herbicide composition in an amount ranging from about 0.5 wt% to about 10 wt%, or about 0.5 wt% to about 5 wt%, or about 0.5 wt% to about 3 wt%, or about 0.5 wt% to about 2 wt%.

Where the herbicide composition according to the invention comprises a mixture of different alcohol alkoxylates, they may be present in the same or different amounts.

In one embodiment, the herbicide composition comprises a mixture of C₉-C₁₁ alcohol alkoxylate and C₁₆-C₁₈ alcohol alkoxylate present in a weight ratio of about 1:2, respectively.

The herbicide composition according to the invention comprises a hydrophobic liquid.

The expression “hydrophobic liquid” is intended to mean a substance that (i) is liquid at typical application temperatures of the herbicide composition, for example at least 5° C., or 10° C., or 15° C., or 20° C. or 25° C., and (ii) has little or no solubility in water.

Examples of suitable hydrophobic liquids include, but are not limited to, organic solvents (e.g. xylene, toluene, C₅-C₁₂ alkanes), mineral oil (e.g. paraffin oil), plant oil (e.g. seed oil and terpenes), petroleum distillate (e.g. kerosene, mineral spirits, white spirits, and Stoddard solvent), animal oil and combinations thereof.

Examples of suitable plant oils that may be used include, but are not limited to, methylated seed oil, alkylated seed oil.

In one embodiment, the hydrophobic liquid comprises one or more terpenes.

Examples of suitable terpenes that may be used include, but are not limited to, pinene, nerol, citral, menthol, limonene, careen, cineol, camphene, dipentene and terpinolene.

In one embodiment, the hydrophobic liquid comprises one or more terpenes selected from pinene, nerol, citral, menthol, limonene, careen, cineol, camphene, dipentene, terpinolene and combinations thereof.

In another embodiment, the hydrophobic liquid is sleceted from dipentene, pinene and limonene.

Those skilled in the art will appreciate terpenes are often derived from extracts of plant oils such as gum turpentine, pine oil, eucalyptus oil, conifer oil, tea tree oil and combinations thereof.

In one embodiment, the herbicide composition comprises one or more of gum turpentine, pine oil, eucalyptus oil, conifer oil, tea tree oil and combinations thereof.

In one embodiment, the herbicide composition comprises one or more terpenes derived from extracts of one or more of gum turpentine, pine oil, eucalyptus oil, conifer oil, tea tree oil and combinations thereof.

The hydrophobic liquid will generally be present in the herbicide composition in an amount ranging from about 0.1 wt% to about 30 wt%.

When referred to as a concentrate, the herbicide composition will typically comprises more than about 15 wt%, or more than about 20 wt%, or more than about 25 wt% hydrophobic liquid.

In one embodiment, the hydrophobic liquid is present in the herbicide composition in an amount of more than about 15 wt%, or more than about 20 wt%, or more than about 25 wt%.

In another embodiment, hydrophobic liquid is present in the herbicide composition in an amount ranging from about 15 wt% to about 30 wt%, or 20 wt% to about 30 wt%, or 25 wt% to about 30 wt%.

When referred to as a working spray composition, the herbicide composition will typically comprises less than about 10 wt%, or less than about 5 wt%, or less than about 2 wt% hydrophobic liquid.

In one embodiment, the herbicide composition comprises less than about 10 wt%, or less than about 5 wt%, or less than about 2 wt% hydrophobic liquid.

In another embodiment, hydrophobic liquid is present in the herbicide composition in an amount ranging from about 0.1 wt% to about 10 wt%, or about 0.1 wt% to about 5 wt%, or about 0.5 wt% to about 3 wt%, or about 0.5 wt% to about 2 wt%.

The herbicide composition further comprises a pH sensitive hydrogel forming polymer.

By a “pH sensitive hydrogel forming polymer” is meant a polymer that forms a hydrogel in response to a change in pH.

The herbicide composition in accordance with the invention has an acidic pH. At that acidic pH the pH sensitive hydrogel forming polymer is not in the form of a hydrogel. In other words, the herbicide composition in accordance with the invention has an acidic pH that does not promote hydrogel formation of the pH sensitive hydrogel forming polymer.

pH sensitive hydrogel forming polymers suitable for use in accordance with the invention will typically contain a plurality of acid functional groups (e.g. carboxylic acid) that at a suitable acidic pH present in their acid or protonated form (i.e. in a non-hydrogel form). Upon that pH being increased in the direction of an alkaline pH the acid functional groups of the polymer will ionise and in turn promotes formation of the hydrogel.

Such pH sensitive hydrogel forming polymers used in accordance with the invention will therefore typically be those that transitions from not being in the form of a hydrogel at an acidic pH into the form of a hydrogel in response to an increase in pH.

The pH sensitive hydrogel forming polymers may, for example, transition into a hydrogel at a pH greater than about 4, or greater than about 4.5, or greater than about 5, or greater than about 5.5, or greater than about 6, or greater than about 6.5, or greater than 7.

The pH sensitive hydrogel forming polymers may, for example, transition into a hydrogel at a pH in the range of about 4-8, or in the range of about 4.5-7, or in the range of about 5-7, or in the range of about 5.5-7.

Given the pH sensitive hydrogel forming polymer transition into a hydrogel in response to an increase in pH they may also be described as an alkaline hydrogel forming polymer.

Alkaline hydrogel forming polymer might therefore be described as a pH sensitive hydrogel forming polymer that transitions into a hydrogel in response to an increase in pH in the direction of an alkaline pH.

The pH sensitive hydrogel forming polymer used in accordance with the invention does not present in the herbicide composition in its hydrogel form.

The pH sensitive hydrogel forming polymer used in accordance with the invention will be appropriately selected so as to present in its non-hydrogel form at the acidic pH of the herbicide composition.

pH sensitive hydrogel forming polymers used in accordance with the invention may be a homopolymer or copolymer.

pH sensitive hydrogel forming polymers used in accordance with the invention may comprise the polymerised residues of acrylic acid.

The pH sensitive hydrogel forming polymer may have a degree of crosslinking.

In one embodiment, the pH sensitive hydrogel forming polymer comprises the polymerised residues of acrylic acid and optionally one or more alkyl acrylates.

Suitable pH sensitive hydrogel-forming polymers are readily available commercially. For example, sold by Lubrizol under the name Carbopol^{®}.

The pH sensitive hydrogel forming polymer will generally be present in the herbicide composition in an amount ranging from about 0.0002 wt% to about 0.01 wt%.

When referred to as a concentrate, the herbicide composition will typically comprise more than about 0.001 wt%, or more than about 0.005 wt%, or more than about 0.008 wt% pH sensitive hydrogel forming polymer.

In one embodiment, the pH sensitive hydrogel forming polymer is present in the herbicide composition in an amount of more than about 0.001 wt%, or more than about 0.005 wt%, or more than about 0.008 wt%.

In another embodiment, the pH sensitive hydrogel forming polymer is present in the herbicide composition in an amount ranging from about 0.001 wt% to about 0.01 wt%, or 0.005 wt% to about 0.01 wt%, or 0.008 wt% to about 0.01 wt%.

When referred to as a working spray composition, the herbicide composition will typically comprise less than about 0.001 wt%, or less than about 0.0006 wt%, or less than about 0.0004 wt% pH sensitive hydrogel forming polymer.

In one embodiment, the herbicide composition comprises less than about 0.001 wt%, or less than about 0.0006 wt%, or less than about 0.0004 wt% pH sensitive hydrogel forming polymer.

In another embodiment, pH sensitive hydrogel forming polymer is present in the herbicide composition in an amount ranging from about 0.0002 wt% to about 0.001 wt%, or about 0.0002 wt% to about 0.0006 wt%, or about 0.0002 wt% to about 0.0004 wt%.

The herbicide composition also comprises fumed silica.

Fumed silica is often made from the flame pyrolysis of silicon halide compounds or from quartz sand vaporised at high temperature. The resulting silica particles are very small (generally having a primary particle size ranging from about 5 to 50 nm) and have a high surface area (generally ranging from about 50-600 m²/g).

Fumed silica suitable for use in accordance with the invention can be obtained commercially, for example, such as that sold under the name XYSIL^{®}.

In one embodiment, the fumed silica has a primary particle size of about 5 nm to about 20 nm and a surface area of 100 m²/g to about 350 m²/g.

The fumed silica will generally be present in the herbicide composition in an amount ranging from about 0.0003 wt% to about 0.01 wt%.

When referred to as a concentrate, the herbicide composition will typically comprise more than about 0.001 wt%, or more than about 0.004 wt%, or more than about 0.006 wt% of fumed silica. In one embodiment, the fumed silica is present in the herbicide composition in an amount of more than about 0.001 wt%, or more than about 0.004 wt%, or more than about 0.006 wt%.

In another embodiment, the fumed silica is present in the herbicide composition in an amount ranging from about 0.001 wt% to about 0.01 wt%, or 0.004 wt% to about 0.01 wt%, or 0.006 wt% to about 0.01 wt%.

When referred to as a working spray composition, the herbicide composition will typically comprise less than about 0.001 wt%, or less than about 0.0008 wt%, or less than about 0.0006 wt% of fumed silica.

In one embodiment, the herbicide composition comprises less than about 0.001 wt%, or less than about 0.0008 wt%, or less than about 0.0006 wt% of fumed silica.

In one embodiment, the fumed silica is present in the herbicide composition in an amount ranging from about 0.0003 wt% to about 0.001 wt%, or about 0.0003 wt% to about 0.0008 wt%, or about 0.0003 wt% to about 0.0006 wt%.

The fumed silica will generally be present in the herbicide composition in the form of a substantially uniform distribution or dispersion.

The herbicide composition may further comprise one or more other components to assist with preparing and/or application of the composition.

For example, the herbicide composition may comprise a pH modifier such as an alkali metal hydroxide (e.g. sodium hydroxide).

In one embodiment, the herbicide composition comprises water in an amount ranging from about 0.1 wt% to about 10 wt%, or about 0.1 wt% to about 7 wt%, or about 0.1 wt% to about 5 wt%; C₆-C₁₂ fatty acid in an amount ranging from about 30 wt% to about 60 wt%, or about 40 wt% to about 60 wt%, or about 50 wt% to about 60 wt%, or about 55 wt% to about 60 wt%; alcohol alkoxylate in an amount ranging from about 10 wt% to about 25 wt%, or about 15 wt% to about 25 wt%, or about 20 wt% to about 25 wt%; hydrophobic liquid in an amount ranging from about 15 wt% to about 30 wt%, or 20 wt% to about 30 wt%, or 25 wt% to about 30 wt%; pH sensitive hydrogel forming polymer in an amount ranging from about 0.001 wt% to about 0.01 wt%, or 0.005 wt% to about 0.01 wt%, or 0.008 wt% to about 0.01 wt%; and fumed silica in an amount ranging from about 0.001 wt% to about 0.01 wt%, or 0.004 wt% to about 0.01 wt%, or 0.006 wt% to about 0.01 wt%.

In another embodiment, the herbicide composition comprises water in an amount ranging from about 50 wt% to about 98 wt%, or about 70 wt% to about 98 wt%, or about 80 wt% to about 98 wt%, or about 85 wt% to about 95 wt%; C₆-C₁₂ fatty acid in an amount ranging from about 1 wt% to about 10 wt%, or about 1 wt% to about 5 wt%, or about 1 wt%, to about 3 wt%, or about 1 wt% to about 2 wt%; alcohol alkoxylate in an amount ranging from about 0.5 wt% to about 10 wt%, or about 0.5 wt% to about 5 wt%, or about 0.5 wt% to about 3 wt%, or about 0.5 wt% to about 2 wt%; hydrophobic liquid in an amount ranging from about 0.1 wt% to about 10 wt%, or about 0.1 wt% to about 5 wt%, or about 0.5 wt% to about 3 wt%, or about 0.5 wt% to about 2 wt%; pH sensitive hydrogel forming polymer is present in the herbicide composition in an amount ranging from about 0.0002 wt% to about 0.001 wt%, or about 0.0002 wt% to about 0.0006 wt%, or about 0.0002 wt% to about 0.0004 wt%; and fumed silica in an amount ranging from about 0.0003 wt% to about 0.001 wt%, or about 0.0003 wt% to about 0.0008 wt%, or about 0.0003 wt% to about 0.0006 wt%.

The present invention also provides a method of preparing a herbicide composition. That method comprises providing an aqueous silica-containing composition comprising water, fumed silica, and pH sensitive hydrogel forming polymer.

The aqueous silica-containing composition will generally comprise about 90 wt% to about 99.5 wt% water, about 0.25 wt% to about 2.5 wt% fumed silica and about 0.25 wt% to about 2.5 wt% pH sensitive hydrogel forming polymer.

In one embodiment, the aqueous silica-containing composition comprises about 90 wt% to about 99.5 wt% water, about 0.25 wt% to about 2.5 wt% fumed silica and about 0.25 wt% to about 2.5 wt% pH sensitive hydrogel forming polymer.

The aqueous silica-containing composition may be provided by mixing in a vessel formulation components comprising water, fumed silica, and pH sensitive hydrogel forming polymer.

The aqueous silica-containing composition may also comprise one or more other formulation components, for example a component to adjust pH.

In one embodiment, the aqueous silica-containing composition has a pH that is increased in the direction of an alkaline pH by addition of an alkali metal hydroxide such as sodium hydroxide.

If used, a pH adjusting reagent may be introduced in an amount ranging from about 0.001 wt% to about 0.05 wt%.

In one embodiment, a pH adjusting reagent is used to increase the pH of the aqueous silica-containing composition.

Introducing a pH adjusting reagent into the aqueous silica-containing composition will typically be undertaken to increase the pH of the composition so as to initiate transition of the pH sensitive hydrogel forming polymer into a hydrogel. In other words, the pH adjusting reagent will be used to increase the pH of the aqueous silica-containing composition to a pH that causes the pH sensitive hydrogel forming polymer to form a hydrogel.

A pH adjusting reagent that causes an increase in pH may be described as an alkaline pH adjusting reagent.

In one embodiment, an alkaline pH adjusting reagent is introduced into the aqueous silica-containing composition so as to increase its pH to greater than about 4, or greater than about 4.5, or greater than about 5, or greater than about 5.5, or greater than about 6, or greater than about 6.5, or greater than 7.

In another embodiment, an alkaline pH adjusting reagent is introduced into the aqueous silica-containing composition so as to increase its pH in the range of about 4-8, or in the range of about 4.5-7, or in the range of about 5-7, or in the range of about 5.5-7.

In a further embodiment, the aqueous silica-containing composition is provided with a pH that promotes hydrogel formation of the pH sensitive hydrogel forming polymer.

In one embodiment, the aqueous silica -containing composition is provided with a pH of greater than about 4, or greater than about 4.5, or greater than about 5, or greater than about 5.5, or greater than about 6, or greater than about 6.5, or greater than 7 so as to promote hydrogel formation of the pH sensitive hydrogel forming polymer.

In another embodiment, the aqueous silica -containing composition is provided with a pH in the range of about 4-8, or in the range of about 4.5-7, or in the range of about 5-7, or in the range of about 5.5-7so as to promote hydrogel formation of the pH sensitive hydrogel forming polymer.

In one embodiment, the aqueous silica-containing composition has an alkaline pH.

By promoting an increase in the pH of the aqueous silica-containing composition such that the pH sensitive hydrogel forming polymer forms a hydrogel, that composition thickens due to the presence of the hydrogel. Increasing the viscosity of the aqueous silica-containing composition has been found to facilitate maintaining the fumed silica particles with a substantially uniform distribution throughout the composition. In other words, formation of the hydrogel has been found to assist with minimising or preventing undesirable aggregation of the fumed silica particles within the aqueous silica-containing composition. The resulting aqueous silica-containing composition in that thickened state can then be combined with the other herbicide composition constituent components in a manner that promotes excellent dispersion/distribution of the fumed silica particles within the so formed herbicide composition.

It will be appreciated combining such a thickened form of the aqueous silica-containing composition with the other herbicide composition constituent components will nevertheless provide for a final herbicide composition having an acidic pH that does not promote hydrogel formation of the pH sensitive hydrogel forming polymer. In other words, one or more of those other constituent components of the herbicide composition will provide sufficient acidity so as to convert the hydrogel form of the pH sensitive hydrogel forming polymer derived from the aqueous silica-containing composition back into its non-hydrogel form.

The method of preparing the herbicide composition comprises combining the so-formed aqueous silica-containing composition with alcohol alkoxylate to form a liquid alcohol alkoxylate-containing composition.

By forming a “liquid” alcohol alkoxylate-containing composition is meant that at least the alcohol alkoxylate component of the composition is present in liquid form. As some alcohol alkoxylates suitable for use in accordance with the invention may present as a solid at room temperature, the step of combining the aqueous silica-containing composition with the alcohol alkoxylate may require application of heat so as to promote formation of a liquid state of the alcohol alkoxylate being used.

In one embodiment, combining the aqueous silica-containing composition with alcohol alkoxylate is performed with the application of heat.

Depending upon the type of alcohol alkoxylate(s) used, they may be combined with the aqueous silica-containing composition in one or more stages. For example, where a mixture of different alcohol alkoxylates are used, one type of alcohol alkoxylate may be combined with the aqueous silica-containing composition followed by a subsequent and separate addition of a different alcohol alkoxylate.

Irrespective of the manner in which the alcohol alkoxylate is combined with the aqueous silica-containing composition, before proceeding with the next step it will be important for the added alcohol alkoxylate to be in liquid form.

The method of preparing the herbicide composition then includes a step of combining the so-formed liquid alcohol alkoxylate-containing composition with a C₆-C₁₂ fatty acid and a hydrophobic liquid.

The fatty acid and hydrophobic liquid components may be combined with the liquid alcohol alkoxylate-containing composition separately, sequentially or as a mixture.

During the addition of one or more components according to the method of the invention, the composition may be subjected to agitation (e.g. stirring) and/or heating to promote mixing and/or dispersion of the components.

As mentioned, the so-formed herbicide composition has an acidic pH. That acidic pH may be derived inherently on combining all of the components used. Alternatively, the pH of the composition may be adjusted at any time during its preparation so as to ensure the final composition has an acidic pH.

For example, the fatty acid component and/or the pH sensitive hydrogel forming polymer can provide for the acidic pH of the composition.

Alternatively, one or more additional components may be included/introduced in the composition that provide for or assist with providing for the acidic pH of the composition. Such additional components may include, but are not limited to, hydrochloric acid and acetic acid.

The constituent components of the herbicide composition may be combined according to the method of the invention in any suitable amounts to provide for the concentration of components as described herein.

Generally, the method of preparing the herbicide composition will involve combining constituent components in an amount so as to afford a concentrate that can be subsequently diluted with water so as to afford a working composition required for an intended application.

In one embodiment, the so formed concentrate is subsequently diluted with a combination of water and acetic acid so as to afford a working composition required for an intended application (i.e. it is ready to use).

In one embodiment, the method of preparing the herbicide composition comprises combining together the aqueous silica-containing composition in an amount of about 1 wt% to about 5 wt%, the alcohol alkoxylate in an amount of about 15 wt% to about 25 wt%, the C₆-C₁₂ fatty acid in an amount of about 40 wt% to about 60 wt%, and the hydrophobic liquid in an amount of about 20 wt% to about 40 wt%.

In another embodiment, the method of preparing the herbicide composition comprises combining together the aqueous silica-containing composition in an amount of about 1 wt% to about 5 wt%, the alcohol alkoxylate in an amount of about 15 wt% to about 25 wt%, the C₆-C₁₂ fatty acid in an amount of about 40 wt% to about 60 wt%, the hydrophobic liquid in an amount of about 20 wt% to about 40 wt% and acetic acid in an amount ranging from about 0.01 wt% to about 1 wt%.

The present invention further provides a herbicide composition produced according to the method described herein.

The present invention also provides a method of killing a plant or retarding its growth, the method comprising contacting the plant with a herbicide composition according to the present invention.

The present invention further provides controlling plant growth at a locus, the method comprising applying to the locus a herbicide composition according to the present invention.

As used herein, the expression “controlling plant growth at a locus” is intended to mean that plant growth is retarded, inhibited or prevented at the locus. The term “locus” is intended to mean any location where plant growth may occur. For example, the locus may be a region of soil in which a plant may grow or a surface upon which a plant may grow.

Contacting the plant with or applying to the locus a herbicide composition according to the invention may be achieved by conventional means in the application of herbicide compositions. For example, the herbicide composition may be rubbed or poured directly on to the plant or the locus. Alternatively, the herbicide composition may be sprayed onto the plant or the locus.

The present invention also provides for the use of a herbicide composition according to the invention to kill a plant or retard its growth. The present invention further provides for use of a herbicide composition according to the invention to control growth of a plant at a locus.

Use of a herbicide composition according to the invention may be performed as herein described and as is well known to those skilled in the art.

As used herein, the term “alkyl”, used either alone or in compound words denotes straight chain, branched or cyclic alkyl, preferably C₁₋₂₀ alkyl, e.g. C₁₋₁₀ or C₁₋₆. Examples of straight chain and branched alkyl include methyl, ethyl, n-propyl, isopropyl, n-butyl, sec-butyl, t-butyl, n-pentyl, 1,2-dimethylpropyl, 1,1-dimethyl-propyl, hexyl, 4-methylpentyl, 1-methylpentyl, 2-methylpentyl, 3-methylpentyl, 1,1-dimethylbutyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, heptyl, 5-methylhexyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethyl-pentyl, 1,2,3-trimethylbutyl, 1,1,2-trimethylbutyl, 1,1,3-trimethylbutyl, octyl, 6-methylheptyl, 1-methylheptyl, 1,1,3,3-tetramethylbutyl, nonyl, 1-, 2-, 3-, 4-, 5-, 6- or 7-methyloctyl, 1-, 2-, 3-, 4- or 5-ethylheptyl, 1-, 2- or 3-propylhexyl, decyl, 1-, 2-, 3-, 4-, 5-, 6-, 7- and 8-methylnonyl, 1-, 2-, 3-, 4-, 5- or 6-ethyloctyl, 1-, 2-, 3- or 4-propylheptyl, undecyl, 1-, 2-, 3-, 4-, 5-, 6-, 7-, 8- or 9-methyldecyl, 1-, 2-, 3-, 4-, 5-, 6- or 7-ethylnonyl, 1-, 2-, 3-, 4- or 5-propyloctyl, 1-, 2- or 3-butylheptyl, 1-pentylhexyl, dodecyl, 1-, 2-, 3-, 4-, 5-, 6-, 7-, 8-, 9- or 10-methylundecyl, 1-, 2-, 3-, 4-, 5-, 6-, 7- or 8-ethyldecyl, 1-, 2-, 3-, 4-, 5- or 6-propylnonyl, 1-, 2-, 3- or 4-butyloctyl, 1-2-pentylheptyl and the like. Examples of cyclic alkyl include mono- or polycyclic alkyl groups such as cyclopropyl, cyclobutyl, cyclopentyl, cyclohexyl, cycloheptyl, cyclooctyl, cyclononyl, cyclodecyl and the like. Where an alkyl group is referred to generally as “propyl″, ″butyl″ etc., it will be understood that this can refer to any of straight, branched and cyclic isomers where appropriate.

The present invention will hereinafter be described with reference to non-limiting examples.

### EXAMPLES

### Comparative Example 1: Composition 1

Based on the formulation shown in Table 1, a dispersion of fumed silica, water and ethoxylated alcohol was prepared. Nonanoic acid and pine oil was added. The solution was stirred for 15 minutes and filtered through a nylon filter. The resulting solution was sealed and stored in an airtight container.

TABLE 1

Composition 1

| | % By weight |
|---|---|
| Ethoxylated C9-11 alcohol | 13.9 |
| Fumed silica | 0.1 |
| Water | 0.1 |
| Nonanoic acid* | 55.9 |
| Pine oil | 30.0 |

*Nonanoic Acid content: 515.6 g/L

### Comparative Example 2: Composition 2

Based on the formulation shown in Table 2, a dispersion of fumed silica in ethoxylated alcohol was prepared. Nonanoic acid and pine oil was added. The solution was stirred for 15 minutes and filtered through a nylon filter. The resulting solution was sealed and stored in an airtight container.

TABLE 2

Composition 2.

| | % By weight |
|---|---|
| Ethoxylated C12-14 alcohol | 16.9 |
| Fumed Silica | 0.1 |
| Water | 0.2 |
| Nonanoic acid* | 47.8 |
| Pine oil | 35.0 |

*Nonanoic Acid content: 443.0 g/L

### Comparative Example 3: Composition 3

Based on the formulation shown in Table 3, a dispersion of fumed silica, water and ethoxylated alcohol was prepared. Nonanoic acid and dipentene was added. The solution was stirred for 15 minutes and filtered through a nylon filter. The resulting solution was sealed and stored in an airtight container.

TABLE 3

Composition 3

| | % By weight |
|---|---|
| Ethoxylated C12-14 alcohol | 16.9 |
| Fumed Silica | 0.1 |
| Water | 0.2 |
| Nonanoic acid* | 47.8 |
| Dipentene | 35.0 |

*Nonanoic Acid content: 424.8 g/L

### Comparative Example 4: Composition 4

Based on the formulation shown in Table 4, a dispersion of fumed silica, water and ethoxylated C9-11 alcohol was prepared. Ethoxylated C18 alcohol was heated to 40° C., melted and added to the dispersion under stirring. The product was warmed to 40° C. and agitated. Nonanoic acid and dipentene was added. The composition was stirred for 15 minutes and cooled to room temperature and filtered through a nylon filter. The resulting product was sealed and stored in an airtight container.

TABLE 4

Composition 4

| | % By weight |
|---|---|
| Ethoxylated C9-11 alcohol | 6.0 |
| Fumed Silica | 0.1 |
| Water | 0.2 |
| Ethoxylated C18 alcohol | 11.7 |
| Nonanoic acid* | 50.0 |
| Dipentene | 32.0 |

*Nonanoic Acid content: 445.9 g/L

### Comparative Example 5: Composition 5

Based on the formulation shown in Table 5, a dispersion of Carbopol acrylic polymer in water ethoxylated C9-11 alcohol was prepared. Ethoxylated C18 alcohol was heated to 40° C., melted and added to the dispersion under stirring. The product was warmed to 40° C. and agitated. Nonanoic acid and dipentene was added. The composition was stirred for 15 minutes and cooled to room temperature and filtered through a nylon filter. The resulting product was sealed and stored in an airtight container.

TABLE 5

Composition 5

| | % By weight |
|---|---|
| Ethoxylated C9-11 alcohol | 6.0 |
| Carbopol acrylic polymer | 0.1 |
| Water | 0.2 |
| Ethoxylated C18 alcohol | 11.7 |
| Nonanoic acid* | 50.0 |
| Dipentene | 32.0 |

*Nonanoic Acid content: 445.9 g/L

### Example 1: Composition 6

Based on the formulation shown in Table 6, a silica colloid composition was prepared by adding fumed silica and Carbopol acrylic polymer to water under stirring. Sodium hydroxide solution was added to increase the pH of the liquid to 5.5 and thicken the liquid through formation of a hydrogel polymer, which helped maintain the silica in a well dispersed state.

The composition of Table 7 was produced by adding the silica colloid composition (Table 6) to ethoxylated C9-11 alcohol. Ethoxylated C18 alcohol was heated to 40° C., melted and added to the dispersion under stirring. The product was warmed to 40° C. and agitated. Nonanoic acid and pure gum turpentine was added. The composition was stirred for 15 minutes and cooled to room temperature and filtered through a nylon filter. The resulting product had an acidic pH and was sealed and stored in an airtight container.

TABLE 6

Silica colloid composition

| | % By weight |
|---|---|
| Water | 99.1 |
| Fumed silica (300 m²/g) | 0.5 |
| Carbopol acrylic polymer | 0.3 |
| Sodium hydroxide solution (50%) | 0.1 |

TABLE 7

Composition 6

| | % By weight |
|---|---|
| Ethoxylated C9-11 alcohol | 6.5 |
| Silica colloid composition | 2.0 |
| Ethoxylated C18 alcohol | 12.5 |
| Nonanoic acid* | 50.0 |
| Pure gum turpentine | 29.0 |

*Nonanoic Acid content: 455.7 g/L

### Example 2: Composition 7

Based on the formulation shown in Table 8, a silica colloid composition was prepared by adding fumed silica and Carbopol acrylic polymer to water under stirring. Sodium hydroxide solution was added to increase the pH of the liquid to 5.5 and thicken the liquid through formation of a hydrogel polymer, which helped maintain the silica in a well dispersed state.

The composition of Table 9 was produced by adding silica colloid composition (Table 8) to ethoxylated C12-14 alcohol. Ethoxylated C18 alcohol was heated to 40° C., melted and added to the dispersion under stirring. The product was warmed to 40° C. and agitated. Nonanoic acid and pure gum turpentine was added. The composition was stirred for 15 minutes and cooled to room temperature and filtered through a nylon filter. The resulting product had an acidic pH and was sealed and stored in an airtight container.

TABLE 8

Silica Colloid Composition

| | % By weight |
|---|---|
| Water | 99.0 |
| Fumed silica (350 m²/g) | 0.6 |
| Carbopol acrylic polymer | 0.3 |
| Sodium hydroxide solution (50%) | 0.1 |

TABLE 9

Composition 7

| | % By weight |
|---|---|
| Ethoxylated C12-14 alcohol | 6.4 |
| Silica colloid composition | 2.2 |
| Ethoxylated C18 alcohol | 12.8 |
| Nonanoic acid* | 49.4 |
| Pure gum turpentine | 29.2 |

*Nonanoic Acid content: 450.4 g/L

### Example 3: Composition 8

Based on the formulation shown in Table 10, a silica colloid composition was prepared by adding fumed silica and Carbopol acrylic polymer to water under stirring. Sodium hydroxide solution was added to increase the pH of the liquid to 5.5 and thicken the liquid through formation of a hydrogel polymer, which helped maintain the silica in a well dispersed state.

The composition of Table 11 was produced by adding silica colloid composition (Table 10) to ethoxylated C9-11 alcohol. Ethoxylated C18 alcohol was heated to 40° C., melted and added to the dispersion under stirring. The product was warmed to 40° C. and agitated. Nonanoic acid and dipentene was added. The composition was stirred for 15 minutes and cooled to room temperature and filtered through a nylon filter. The resulting product had an acidic pH and was sealed and stored in an airtight container.

TABLE 10

Silica Colloid Composition

| | % By weight |
|---|---|
| Water | 99.00 |
| Fumed silica (200 m²/g) | 0.50 |
| Carbopol acrylic polymer | 0.45 |
| Sodium hydroxide solution (50%) | 0.05 |

TABLE 11

Composition 8

| | % By weight |
|---|---|
| Ethoxylated C9-11 alcohol | 7.2 |
| Silica colloid composition | 2.2 |
| Ethoxylated C18 alcohol | 14.3 |
| Nonanoic acid* | 49.9 |
| Dipentene | 26.4 |

*Nonanoic Acid content: 444.1 g/L

### Example 4: Composition 9

Based on the formulation shown in Table 12, Composition 9, a working spray mixture of low pH was prepared. Acetic acid was used to reduce the pH of the emulsion. The resulting product had an acidic pH and was sealed and stored in an airtight container.

TABLE 12

Composition 9

| | % By weight |
|---|---|
| Acetic Acid (54%)* | 11.2 |
| Composition 8** | 4.0 |
| Water | 84.8 |

*Acetic Acid content: 60.0 g/L
**Nonanoic Acid content: 20.3 g/L

### Example 5: Field Application of the Compositions 1-9

### Example 5a: Field Trial to Evaluate Efficacy of Composition 1 for the Control of Weeds in Fallow

A field trial was conducted in Victoria to evaluate the efficacy of Composition 1 (515.6 g/L nonanoic acid) for the control of weeds in fallow. The treatments conducted used 7 L of Composition 1 per 100 L of water at spray application volumes of 1000 L/ha and dilute spray to the point of run-off. This was compared with Slasher Weed Killer (525 g/L nonanoic acid at 7L per 100L) in a spray application volume of 1000 L/ha water or a dilute spray to the point of run-off and an untreated control.

Broadleaf weed species included plantain (Plantago Major) [PLANTA], marshmallow (Malva parviflora) [MALPO] and sowthistle (Sonchus oleraceus) [SONOL]. Grass weed species included annual bluegrass (Poa Annua) [POAAN] only.

One foliar application was applied to weeds at the BBCH 13-15 growth stage. Weed density was assessed prior to treatment application at 0 days after application (0DAA) and 27DAA. Weed brownout was assessed at 7DAA, 17DAA and 27DAA.

Composition 1 at 7 L/100 L applied in a spray volume of 1000 L/ha or as a dilute spray to run-off provided significant brownout of PLANTA and MALPA and significant brownout and density reduction of SONOL and POAAN compared to the untreated control in fallow with the highest rate and the dilute spray to run-off application generally superior to the lower rate.

When compared with Slasher Weed Killer, Composition 1 was between 5-10% less efficacious for the control of PLANTA, MALPA, SONOL and POAAN.

### Example 5b: Field Trial to Evaluate Efficacy of Compositions 2, 3 and 4 for the Control of Weeds in Fallow

A field trial was conducted in Victoria to evaluate Compositions 2 (Nonanoic Acid content: 443.0 g/L), Composition 3 (Nonanoic Acid content: 424.8 g/L) and Composition 4 (Nonanoic Acid content: 445.9 g/L) for control of bull thistle (Cirsium vulgare), butter weed (Packera Glabella), annual ryegrass (Lolium rigidum) and bermuda buttercup (Oxalis Pes-caprae) in fallow. Compositions 2-4 were each applied at 7 L per 100 L of water as a spray mixture by boom spray with a flat fan nozzle in spray volumes of 1000 L/ha and to the point of run-off. Composition 2-4 were compared to Slasher Weed Killer (525 g/L nonanoic acid at 7 L per 100 L) applied by boom spray in a total spray volume of 1000 L/ha and an untreated control. All herbicide treatments were applied with a coarse spray quality to actively growing weeds. At the time of application bull thistle, butter weed and bermuda buttercup were at the 5-6 leaf stage, and annual ryegrass was 3-4 leaf stage.

A pre-spray weed count by species was conducted at 0 days after application (0DAA) with surviving weed numbers by species assessed at 27DAA. Weed brownout by species was assessed at 7, 14 and 27DAA.

Compositions 2 (Nonanoic Acid content: 443.0 g/L) and Composition 3 (Nonanoic Acid content: 424.8 g/L) were less effective (2-5%) than Slasher Weed Killer at the same application rates. Composition 2 and 3 achieved a control of broadleaf weeds when applied above 1000 L/ha, with 92% and 96% control of bull thistle compared to the untreated control, 82% and 85% control of butter weed, and 92% and 90% control of bermuda buttercup. It was not so effective for the control of annual ryegrass, despite good brownout at 14DAA, recording 40% and 45% control compared to the untreated control at 27DAA.

Composition 4 (Nonanoic Acid content: 445.9 g/L) was effective for the control of broadleaf weeds when applied at 1000 L/ha, with complete control of bull thistle compared to the untreated control, 93% control of butter weed and 95% control of bermuda buttercup. It was less effective for the control of annual ryegrass, despite excellent brownout at 14DAA, recording 60% control compared to the untreated control at 27DAA.

Composition 4 demonstrated a strong rate response for weed brownout. When applied above 1000L/ha, Composition 4 provided slightly lower control of annual ryegrass to equivalent control of broadleaf weeds when compared with Slasher Weed Killer.

### Example 5c: Field Trial to Evaluate Efficacy of Composition 5 for the Control of Weeds in Fallow

A field trial was conducted in Victoria to evaluate the efficacy of Composition 5 (Nonanoic Acid content: 445.9 g/L) for the control of weeds in fallow. Treatments included 7 L Composition 5 per 100 L of water at spray application volumes of 1000 L/ha. Treatments were compared with Slasher Weed Killer (525 g/L nonanoic acid) at 7 L per 100 L in a spray application volume of 1000 L/ha water and an untreated control.

Broadleaf weed species included prickly lettuce (Lactuca serriola), hedge mustard (Sisymbrium officiale) and sowthistle (Sonchus oleraceus) [SONOL]. Grass weed species included buffalo grass (Stenotaphrum secundatum) only.

One foliar application was applied to weeds at the BBCH 10-12 growth stage. Weed density was assessed prior to treatment application at 0 days after application (0DAA) and 27DAA. Weed brownout was assessed at 7DAA, 17DAA and 27DAA.

Composition 5 (Nonanoic Acid content: 445.9 g/L) at 7 L/100 L applied in a spray volume of 1000 L/ha provided advance brownout and density reduction of hedge mustard (87%) and sowthistle (85%) and limited brownout and density reduction of prickly lettuce (75%) and buffalo grass (77%) compared to the untreated control.

Composition 5 was generally less efficacious than Slasher Weed Killer for the control of hedge mustard, sowthistle, prickly lettuce and buffalo grass. Slasher achieved a brownout and density reduction of 93 - 96%.

### Example 5d: Field Trial to Evaluate Efficacy of Compositions 6, 7 and 8 for the Control of Weeds in Fallow

A field trial was conducted in Victoria to evaluate and compare Composition 6 (Nonanoic Acid content: 455.7 g/L), Composition 7 (Nonanoic Acid content: 455.7 g/L) and Composition 8 (Nonanoic Acid content: 444. 1 g/L) for the control of common mallow (malva neglecta), prickly sowthistle (sonchus asper), cape dandelion (arctotheca calendula) and annual bluegrass (poa annua) in fallow. Treatments included Compositions 6-8 each applied at 5 L per 100 L of water in a spray volume of 1000 L/ha. Treatments were applied as a foliar spray to actively growing weeds at the BBCH 10-14 growth stage using hollow cone nozzles in a spray volume of 1000 L/ha.

Treatments were compared with Slasher Weed Killer (525 g/L nonanoic acid) at 7 L per 100 L in a spray application volume of 1000 L/ha water and an untreated control.

Weed brownout was assessed at 7 days after application (7DAA), 14DAA and 28DAA, with weed density also assessed at 28DAA.

Composition 6 (Nonanoic Acid content: 455.7 g/L) and Composition 7 (Nonanoic Acid content: 455.7 g/L) at 5 L per 100 L of water were at least as efficacious as Slasher Weed Killer (Nonanoic Acid content: 525 g/L) at 7 L per 100 L of water for the control of common mallow, prickly sowthistle and cape dandelion, and annual bluegrass delivering a reduced level of regrowth. Composition 8 (Nonanoic Acid content: 444. 1 g/L) at 5 L per 100 L of water was noticeably more efficacious than Slasher Weed Killer (Nonanoic Acid content: 525 g/L) at 7 L per 100 L of water delivering a reduced level of regrowth.

At 1000 L/ha Composition 8 provided at 5 L per 100 L of water significant control of common mallow, prickly sowthistle and cape dandelion, and annual bluegrass. By 28DAA, Composition 8 achieved 93% of common mallow, 100% brownout of prickly sowthistle and cape dandelion, 96% brownout of annual bluegrass.

Slasher Weed Killer at 7 L per 100 L of water provided good control of common mallow, prickly sowthistle and cape dandelion, and annual bluegrass. By 28DAA, Slasher Weed Killer achieved 90% of common mallow, 90% brownout of prickly sowthistle and cape dandelion, 88% brownout of annual bluegrass.

Compositions 6-8 were used at a lower dosage rate compared to Slasher Weed Killer and yet provided equal or better results.

### Example 5e: Field Trial to Evaluate Efficacy of Herbicide Composition 8 for the Control of Weeds in Fallow

A field trial was conducted in South Australia to evaluate Composition 8 (Nonanoic Acid content: 444.1 g/L) for the control of brome grass (bromus sp.), long fruited turnip (brassica tournefortii), capeweed (arctotheca calendula), sand rocket, (diplotaxis tenuifolia). Treatments included Composition 8 applied at 50 ml/L of water, in a spray volume of approx 750 and 1000 L/ha. Treatments with Composition 8 were compared with Slasher Weed Killer (Nonanoic Acid content: 525 g/L) applied at 70 mL/L in a spray volume of approx. 1000 L/ha and an untreated control (UTC). Treatments were applied as a foliar spray to actively growing weeds using extended range flat fan nozzles (Lechler LU 120-08 nozzles).

Weed density was assessed prior to treatment application at 0 days after application (0DAA) and 27DAA. Weed brownout was assessed at 7DAA, 17DAA and 27DAA.

Composition 8 (Nonanoic Acid content: 444.1 g/L) applied at 50ml/L of water provided significant control of all weeds compared to the UTC at all assessment timings. By 28DAA, the Composition 8 achieved at both 750 and 1000 L/ha greater than 90% brownout of all weeds.

Slasher Weed Killer applied at 70 mL/L provided comparable weed control at greater than 90% brown out of weeds at 1000 L/ha application.

This field trial demonstrated the high performance of Composition 8 as herbicide for effective weed control in fallow. Compared to Slasher Weed Killer, Composition 8 delivered its performance with a lower concentration of the active ingredient, nonanoic acid (Composition 8 444.1 g/L vs Slasher Weed Killer 525 g/L), at higher dilution level (Composition 8 50 g/L vs Slasher Weed Killer 70 g/L) and at lower application rate (Composition 8 750 L/ha vs Slasher Weed Killer 1,000 L/ha). Composition 8 achieved effective weed control at a 16.65 kg nonanoic acid/ha rate vs Slasher Weed Killer at 36.75 nonanoic acid/ha rate.

### Example 5f: Field Trial to Evaluate Efficacy of Herbicide Composition 9 for the Control of Weeds in Fallow

A field trial was conducted in New South Wales to evaluate and compare Composition 8 (Nonanoic Acid content: 444.1 g/L) applied at 50ml/L of water (Nonanoic Acid content: 21.1 g/L in spray mixture) and Composition 9 Spray Mixture (Acetic Acid content: 60.0 g/L, Nonanoic Acid content: 20.3 g/L) for the control of black grass (eragrostis setifolia) and volunteer canola (brassica napus) in fallow. Treatments were compared with Slasher Weed Killer (525 g/L nonanoic acid) at 70 ml/L of water (Nonanoic Acid content: 34.3 g/L in spray mixture) and an untreated control (UTC)..

Treatments were applied as a foliar spray to actively growing weeds at the BBCH 10-14 growth stage using hollow cone nozzles in a spray volume to the point of runoff with hollow cone nozzles to simulate application in home garden or amenity areas.

Weed brownout (visual% compared to untreated control) was assessed at 7DAA (days after application) and weed density (plants /m2) was assessed at 0 and 15DAA.

Composition 8 (Nonanoic Acid content: 444.1 g/L) applied at 50ml/L of water (Nonanoic Acid content: 21.1 g/L in spray mixture) provided significant control of all weeds compared to the UTC at all assessment timings. Black grass brownout (% leaf area) was 94% after 3DAA and 94% after 7DAA. Black grass count (no./m2) after 15DAA was 6.5 versus 20 for UTC. Volunteer canola brownout (% leaf area) was 99% after 3DAA and 99% after 7DAA. Volunteer canola count (no./m2) after 15DAA was 0.4 versus 7.5 for UTC.

Composition 9 Spray Mixture (Acetic Acid content: 60.0 g/L, Nonanoic Acid content: 20.3 g/L) provided superior control of all weeds compared to the UTC at all assessment timings. Black grass brownout (% leaf area) was 100% after 3DAA and 99% after 7DAA. Black grass count (no./m2) after 15DAA was 2.5 versus 20 for UTC. Volunteer canola brownout (% leaf area) was 100% after 3DAA and 100% after 7DAA. Volunteer canola count (no./m2) after 15DAA was 0 versus 7.5 for UTC.

Slasher Weed Killer (525 g/L nonanoic acid) at 70ml/L of water provided medium control of all weeds compared to the UTC at all assessment timings. Black grass brownout (% leaf area) was 93% after 3DAA and 76% after 7DAA. Black grass count (no./m2) after 15DAA was 12.8 versus 20 for UTC. Volunteer canola brownout (% leaf area) was 98% after 3DAA and 93% after 7DAA. Volunteer canola count (no./m2) after 15DAA was 0.3 versus 7.5 for UTC.

Comparing the two spray mixtures containing Nonanoic Acid only, Composition 8 (Nonanoic Acid content: 444.1 g/L) applied at 50 ml/L of water (Nonanoic Acid content: 21.1 g/L in spray mixture) provided numerically higher weed control than Slasher Weed Killer (525 g/L nonanoic acid) at 70 ml/L of water (Nonanoic Acid content: 34.3 g/L in spray mixture) despite its lower Nonanoic Acid Active Ingredient content of 21.1 g/L versus 34.3 g/L for Slaser. The difference in performance is particularly evident for the more difficult to eradicate black grass. Black grass count (no./m2) after 15DAA was 6.5 for Composition 8 versus 12.8 for Slasher Weed Killer versus 20 for UTC.

Composition 9 Spray Mixture (Acetic Acid content: 60.0 g/L, Nonanoic Acid content: 20.3 g/L) provided superior control of all weeds compared to high performing Composition 8 (Nonanoic Acid content: 444.1 g/L) applied at 50 ml/L of water (Nonanoic Acid content: 21.1 g/L in spray mixture) and Slasher Weed Killer (525 g/L nonanoic acid) at 70 ml/L of water (Nonanoic Acid content: 34.3 g/L in spray mixture). The difference is particularly evident for the more difficult to eradicate black grass. Black grass count (no./m2) after 15DAA was 2.5 for Composition 9 versus 6.5 for Composition 8 versus 12.8 for Slasher Weed Killer versus 20 for UTC.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A herbicide composition having an acidic pH, the composition comprising water, a C₆-C₁₂ fatty acid, an alcohol alkoxylate, a hydrophobic liquid, a pH sensitive hydrogel forming polymer, and fumed silica, wherein the pH of the composition does not promote hydrogel formation of the pH sensitive hydrogel forming polymer.

2. The herbicide composition according to claim 1, wherein water is present in an amount ranging from about 0.1 wt% to about 10 wt%.

3. The herbicide composition according to claim 1, wherein water is present in an amount ranging from about 50 wt% to about 98 wt%.

4. The herbicide composition according to claim 1, wherein water is present in an amount ranging from about 0.1 wt% to about 10 wt%, C₆-C₁₂ fatty acid is present in an amount ranging from about 30 wt% to about 60 wt%, alcohol alkoxylate is present in an amount ranging from about 10 wt% to about 25 wt%, hydrophobic liquid is present in an amount ranging from about 15 wt% to about 30 wt%, pH sensitive hydrogel forming polymer is present in an amount ranging from about 0.001 wt% to about 0.01 wt%, and fumed silica is present in an amount ranging from about 0.001 wt% to about 0.01 wt%.

5. The herbicide composition according to claim 1, wherein water is present in an amount ranging from about 50 wt% to about 98 wt%, C₆-C₁₂ fatty acid is present in an amount ranging from about 1 wt% to about 10 wt%, alcohol alkoxylate is present in an amount ranging from about 0.5 wt% to about 10 wt%, hydrophobic liquid is present in an amount ranging from about 0.1 wt% to about 10 wt%, pH sensitive hydrogel forming polymer is present in an amount ranging from about 0.0002 wt% to about 0.001 wt% and fumed silica is present in an amount ranging from about 0.0003 wt% to about 0.001 wt%.

6. The herbicide composition according to claim 1, wherein the alcohol alkoxylate is a C₆-C₂₄ alcohol alkoxylate.

7. The herbicide composition according to claim 1, wherein the alcohol alkoxylate comprises a mixture of C₉-C₁₁ alcohol alkoxylate and C₁₆-C₁₈ alcohol alkoxylate.

8. The herbicide composition according to claim 1, wherein the C₆-C₁₂ fatty acid is selected from caproic acid, enanthic acid, caprylic acid, nonanoic acid, capric acid, udecylic acid, lauric acid and sebacic acid.

9. The herbicide composition according to claim 8, wherein the C₆-C₁₂ fatty acid comprises nonanoic acid.

10. The herbicide composition according to claim 1, wherein the hydrophobic liquid comprises one or more terpenes selected from pinene, nerol, citral, menthol, limonene, careen, cineol, camphene, dipentene, terpinolene and combinations thereof.

11. The herbicide composition according to claim 1, further comprising acetic acid.

12. A method of killing a plant or retarding its growth, the method comprising contacting the plant with a herbicide composition according to claim 1.

13. A method of preparing a herbicide composition, the method comprising:
providing an aqueous silica-containing composition comprising water, fumed silica, and pH sensitive hydrogel forming polymer;
combining the aqueous silica-containing composition with an alcohol alkoxylate to form a liquid alcohol alkoxylate-containing composition; and
combining the liquid alcohol alkoxylate-containing composition with a C₆-C₁₂ fatty acid and a hydrophobic liquid to produce the herbicide composition;
wherein the herbicide composition has an acidic pH that does not promote hydrogel formation of the pH sensitive hydrogel forming polymer.

14. The method according to claim 13, wherein the aqueous silica-containing composition is provided with a pH that promotes hydrogel formation of the pH sensitive hydrogel forming polymer.

15. The method according to claim 13, wherein the C₆-C₁₂ fatty acid comprises nonanoic acid.

16. The method according to claim 13, wherein the herbicide composition produced is combined with water and acetic acid to afford a ready to use herbicide composition having an acidic pH that does not promote hydrogel formation of the pH sensitive hydrogel forming polymer.
